(19) United States
(12) Patent Application Publication
(10) Pub. No.: US 2009/0301006 A1
(43) Pub. Date: Dec. 10, 2009

(54) Bonded Window

(75) Inventor: Randolf Karrer, Schwetzingen (DE)

Correspondence Address: H.B. FULLER COMPANY;Patent Department, 1200 WILLOW LAKE BLVD., P.O. BOX 64683, ST. PAUL, MN, 55164-0683, US

(73) Assignee: H.B. Fuller Licensing & Financing, Inc., St. Paul, MN (US)

(21) Appl. No.: 12/161,633

(22) PCT Filed: Dec. 18, 2006
(86) PCT No.: PCT/EP06/12162

§ 371 Date: Jan. 16, 2009

(30) Foreign Application Priority Data
Jan. 23, 2006 (DE) 10 2006 003 288.8

(51) Int. Cl. E06B 3/66; E06B 7/16; E06B 3/54

(52) U.S. Cl. 52/204.6; 49/475.1

(57) ABSTRACT

A multi-pane window unit is described which comprises
a. a first glass pane (1) having an inner surface (1.1) with an edge region and an outer surface (1.2) with an edge region,
b. a second glass pane (2) having an inner surface (2.1) with an edge region and an outer surface (2.2) with an edge region,
c. a spacer composed of
   (c a) a hollow profile (3) which can be filled with moisture-absorbing material, and whose inner space for the moisture-absorbing material is defined at least by two side walls (5) and a rear wall (6), wherein the inner space has a connection to the gap between the panes, and wherein a first sealant (7) is arranged between the side walls (5) of the hollow profile and the inner surfaces of the first and second glass panes, or
   (c b) a spacer (8) made of a non-flowing polymeric material
d. a window sash or window frame with a rebate (9) which accommodates the glass panes, and
   a second adhesive/sealant layer (10) for bonding the glass panes and the spacer to the window sash in a force-fitting and sealing manner.

The invention relates to a window unit containing a multi-pane insulating glass module bonded in a force-fitting manner to the window sash or window frame, and to a method of producing such a multi-pane window unit.

Multi-pane insulating glasses have become generally used in the construction industry because of the advantages they offer. The improved thermal and sound insulation compared to single glazing deserves particular emphasis. It is well-known that multi-pane insulating glass systems consist of two or more panes of glass arranged in parallel, which are joined together in their edge region in such a way that the gap enclosed by the panes is sealed against the ambient air such that no moisture can penetrate that gap. In addition, the edge joint is domed in such a way that it can withstand all the mechanical and chemical loads resulting from changing climatic conditions. In many cases, this gap is also filled with dry gases, which serve to increase the thermal insulation or sound insulation compared to an air filling.

In the standard commercially available insulating glass arrangements, rigid spacers ensure the desired distance between the panes of glass. In the most common embodiment, the spacer consists of a hollow aluminium or sheet steel profile. It is disposed near the edges of the glass panes in such a way that the spacer, together with the edge regions of the glass pane, forms an outwardly facing channel to accommodate sealants and adhesives. Usually, the side of the spacer facing the gap between the glass panes has small apertures, and the cavity of the spacer serves to receive a desiccant to absorb the moisture and any solvent possibly remaining in the air or gas gap between the panes. This prevents moisture from condensing on the inside of the insulating glass panes when the ambient temperature is low. In high-quality insulating glass systems, there is a sealant with a high water vapour barrier effect between the surfaces of the spacer facing the glass panes and the glass surface. Formulations based on polyisobutylene and/or butyl rubber are used for this purpose as a rule. The channel formed by the outwardly facing surface of the spacer and the edge regions of the glass panes is usually filled with a two-component adhesive/sealant, which produces a sufficiently strong bond between the insulating glass arrangement. This adhesive/sealant must adhere well to the panes and also be elastic enough to withstand the expansion and contraction movements of the glass panes under changing climatic conditions.

Usually, an insulating glass unit produced in this way is either fitted into the window sash using glazing blocks or undergoes a further assembly step in the form of overturn bonding or rebate base bonding.

In addition to the above-mentioned spacers made from metal profiles, spacers made from hollow plastic profiles have also been proposed and used in more recent times, which may optionally be laminated with a metal film in order to enhance the water vapour barrier effect. In addition, spacers made from a strip of thermoplastic polymer based on polyisobutylene or butyl rubber are known, which, in the centre of the polymer matrix, may optionally contain a planar structure with an undulating shape, the planar extent of which is arranged perpendicularly to the glass panes. This planar structure with an undulating shape has the function of the spacer and acts at the same time as a water vapour barrier; spacers of this kind are described in EP-A-517067, for example.

Multiple-pane insulating glass units are known from U.S. Pat. No. 4,831,799 which use a strip of elastic foam as a spacer, which may be flexible or semi-rigid. The polymer matrix of this strip of foam is supposed to be moisture-permeable, and in addition, said strip of foam is supposed to contain an absorption means for moisture. In addition, this strip of spacer foam can be equipped with a flexible vapour and gas barrier layer, said vapour and gas barrier layer of the spacer facing away from the insulating air space located between the panes. This vapour and gas barrier may contain a plate, a film or layer of vinylidene chloride polymers or copolymers, and in addition, one of the barrier layers may consist of metallised polymer film, such as polyethylene terephthalate, for example. The polymer foam matrix may be constructed from various thermoplastic polymers, such as silicone polymers, polyurethanes or also thermoplastic elastomers. Examples of these are ethylene-propylene-diene copolymers (EPDM); further examples are thermoplastic polyolefins or styrene block copolymers.

In the standard technology of multi-pane window units, the insulating glass unit is first of all produced separately from the two or more glass panes, the spacers, the seal providing the water vapour barrier, and the elastomeric edge collar, and this insulating glass unit produced in this way is then inserted into the window sash or window frame in a separate step, often even at a different manufacturing location.

In order to simplify the assembly of insulating glazing, EP 1070824 A2 proposes that the insulating glass module should be adhered in a rebate of a profile frame. For this purpose, an adhesive is supposed to be applied in a strip along the rebate surface of the surrounding frame rebate parallel to the insulating glazing before the insulating glazing is inserted into the rebate. In the insertion step, the insulating glazing is then pressed against the surrounding strip of adhesive, which provides the connection between the insulating glass unit and the profile frame. The disadvantage of this construction is that the load imposed by the insulating glass module must be borne exclusively via the lipped outer edge on the profile frame gripping the insulating glazing. A further disadvantage is that only the inner pane is supported on the frame, and not the outer pane, which is partially supported also by the inner pane via the connection at the edge between the inner and outer panes.

From EP 1004740 A2 it is known for a pane of laminated glass which is inserted into a frame rebate to be fixed by means of a layer of adhesive that fills out the peripheral gap between the pane of laminated glass and the rebate. The teaching of this document is directed towards the production of explosion-proof windows, but this document does not disclose bonding in multi-pane insulating glass modules.

WO 02/081854 discloses a sash for a window or door, in which the sash has a rebate accommodating insulating glazing. The insulating glazing in this case is supposed to be fixed in the rebate with an adhesive layer which fills out a peripheral gap between the faces of the insulating glazing and the peripheral surface of the rebate opposite these faces at least in the peripheral areas of the insulating glazing. In this case, a limiting element running in the peripheral direction is supposed to be provided for the adhesive layer in the area of a covering pane of the insulating glazing facing the rebate surface. According to the teaching of this document, a preassembled insulating glass module is inserted into the rebate of the profile frame in a horizontal position and then bonded. In a particular embodiment, the adhesive is supposed to be injected or pressed under pressure into the peripheral gap between the rebate surface and the faces of the insulating glazing. In this case, therefore, the insulating glass module consisting of the two or more panes, the spacers and the edge seal is likewise prefabricated separately. Since the adhesive in this case is in direct contact with the adhesive/sealant of the edge compound of the insulating glass in order to bond the window sash to the insulating glass unit in a force-fitting manner, it must be ensured that the two layers of adhesive do not have a negative influence on each other over the life of the window sash, for example as a result of components migrating from one layer of adhesive into the other layer of adhesive, which can lead to a weakening of the bond.

The production of window units with high-quality insulating glass arrangements therefore naturally consists of a number of complex sequences of operations and is very cost-intensive despite the high degree of automation on large production lines. Proceeding from this prior art, the problem on which this invention is based is to provide a window unit containing a multi-pane insulating glass module which is bonded in a force-fitting manner to the window sash or window frame, which is simple to manufacture and can preferably be produced in a single manufacturing sequence.

The solution can be gathered from the claims. It consists substantially in providing a multi-pane window unit comprising
(a) a first glass pane (1) having an inner surface (1.1) with an edge region and an outer surface (1.2) with an edge region,
(b) a second glass pane (2) having an inner surface (2.1) with an edge region and an outer surface (2.2) with an edge region,
(c) a spacer composed of
   (c a) a hollow profile (3) which can be filled with moisture-absorbing material, and whose inner space for the moisture-absorbing material is defined at least by two side walls (5) and a rear wall (6), wherein the inner space has a connection to the gap between the panes, and wherein a first sealant (7) is arranged between the side walls (5) of the hollow profile and the inner surfaces of the first and second glass panes, or
   (c b) a spacer (8) made of a non-flowing polymeric material
(d) a window sash or window frame with a rebate (9) which accommodates the glass panes, and
(e) with a second adhesive/sealant layer (10) for bonding the glass panes and the spacer to the window sash in a force-fitting and sealing manner.

In a further embodiment, the multi-pane window unit may also comprise three or more glass panes, each of which is held in its edge region by a spacer to keep them parallel and spaced apart.

A further subject of the present invention is a method of producing complete window units containing a multi-pane insulating glass module, which is produced in a force-fitting manner with the window sash or window frame in a sequence of assembly steps.

The multi-pane window units in accordance with the invention will be described in greater detail in the following with reference to some drawings, in which

FIG. 1 shows the basic structure of a multi-pane window unit in a conventional construction as a sectional drawing.

FIG. 2 shows a section through the rebate with an insulating glass module with a hollow profile as a spacer.

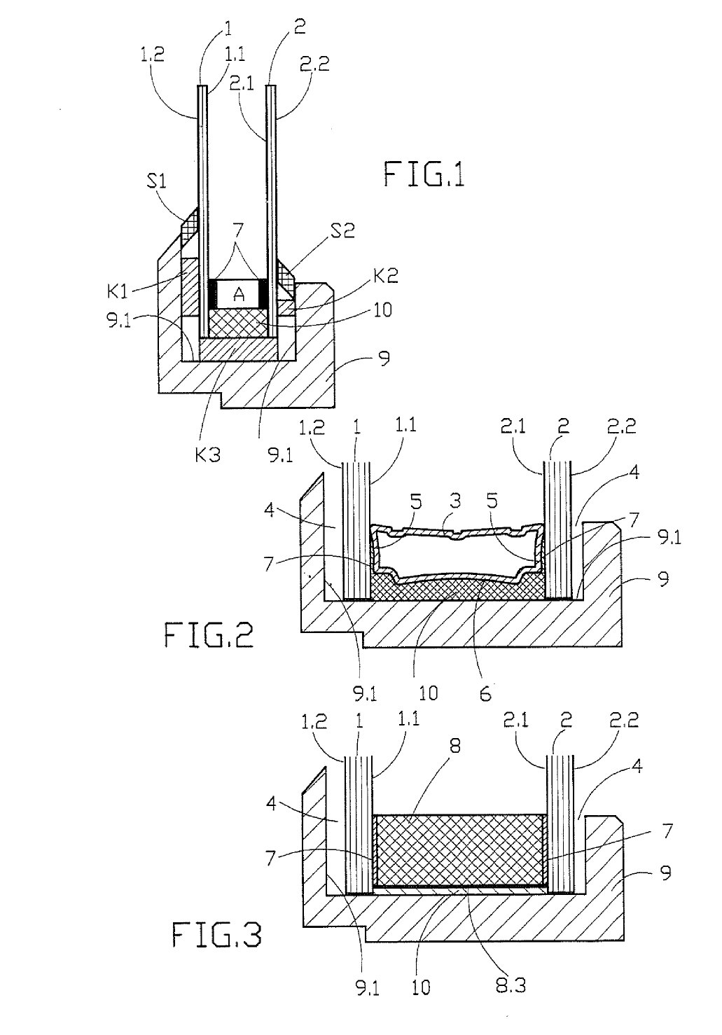

FIG. 3 shows an embodiment with a polymeric spacer profile instead of a hollow profile.

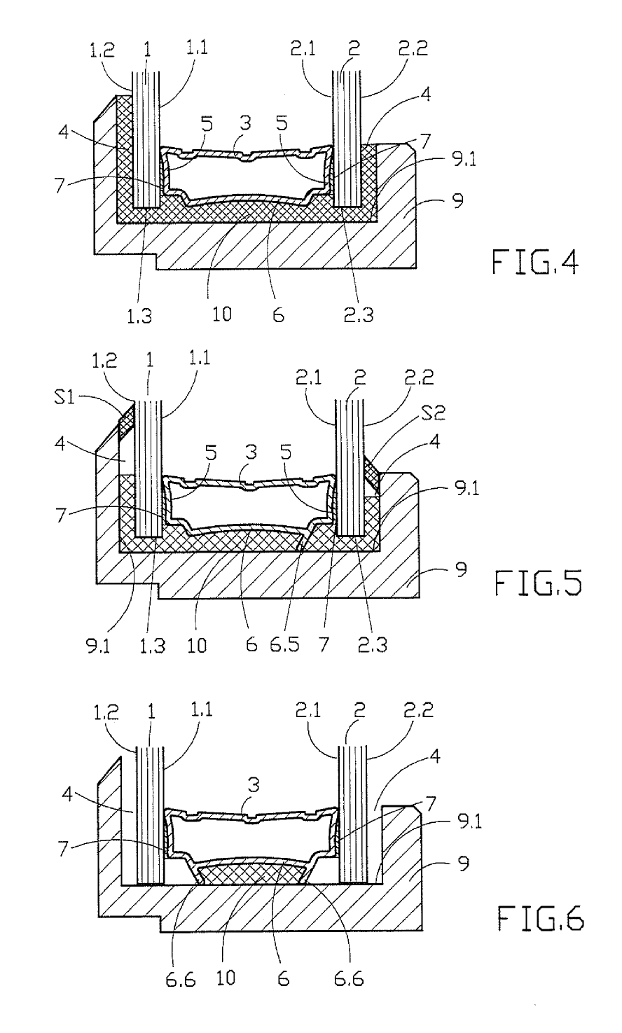

FIG. 4 shows a further embodiment with a hollow profile as a spacer.

FIG. 5 shows a further embodiment with a hollow profile as a spacer, wherein the hollow profile has a web on the rear wall.

FIG. 6 shows a further embodiment with two webs on the rear wall of the hollow profile.

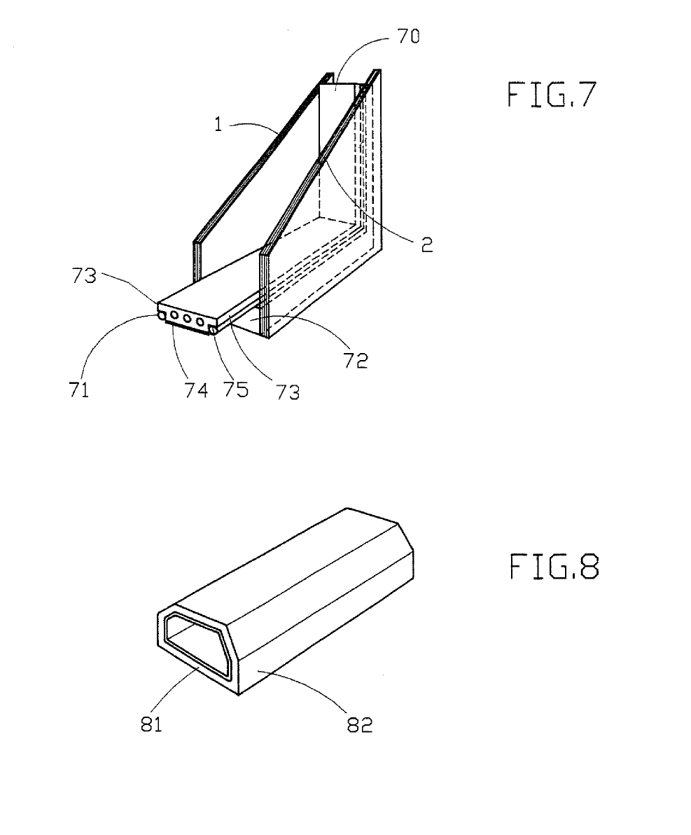

FIG. 7 shows a detailed drawing of the insulating glass module with a polymeric elastomeric profile as a spacer.

FIG. 8 shows a plastic hollow profile with a metal coating.

FIG. 1 shows a cross-section through the profile of a window sash or window frame with an insulating glass module in accordance with the prior art. In this case, the only part of the window sash or window frame shown is the peripheral rebate (9) with its lateral inner surfaces and the lower peripheral surface (9.1). According to the conventional method of production, the insulating glass module is first of all manufactured completely separately from the two panes (1) and (2), and for this purpose the spacer (A) and the first sealant are applied to the first pane 1 in the edge region the inner surface. After this, a further strip of sealant is applied to the further outer surface of the spacer, and the second pane is added such that the two panes are arranged parallel to one another and may optionally be pressed together gently. In this context, the spacer according to the prior art may be a hollow profile made from metallic profiles or plastic profiles or also an elastomeric spacer, as described in U.S. Pat. No. 4,831,799 A. Flexible spacer profiles made from elastomeric foams of this kind are marketed by Edgetech IG under the name “Super Spacer”. In a further prior-art embodiment, the first sealant, which serves as a gas and water vapour barrier, may also already be extruded onto the spacer in a previous working step. After the two glass panes have been preliminarily fixed with the spacers and the first sealant, a second adhesive/sealant (10) is inserted into the U-shaped channel formed in the edge region by spacers and inner surfaces (1.1) and (2.1) of the panes, which is intended to provide a sufficiently strong bond in the insulating glass arrangement. Once the adhesive/sealant (10) has built up sufficient strength, the insulating glass module manufactured in this way is placed in intermediate storage or transported to the window-making company. There, the prefabricated insulating glass module is fitted into the window sash or window frame by means of the “glazing block system”. The lower glazing block (K3) and the lateral glazing blocks (K1) and, where applicable, (K2) are used in order to fix the insulating glass module into the window sash or window frame mechanically using glazing blocks. After that, the edge regions towards the rebate are usually sealed with a sealant both on the outside of the window (S1) and on the inside of the window (S2). Alternatively, the insulating glass module can be bonded with the window sash or window frame in an assembly step other than overturn bonding or rebate base bonding. In the case of rebate base bonding, the place of the lower glazing block (K3) is taken by a peripheral assembly adhesive, as is proposed in WO 02/081851, for example. Since the assembly adhesive (K3) is in permanent direct contact with the adhesive/sealant (10) of the insulating glass module with this type of construction, it must be ensured that the edge joint adhesive/sealant (10) of the insulating glass module and the adhesive (K3) used for rebate base bonding are chemically compatible, so that only a very limited choice of adhesives is available for rebate base bonding: the point is that the chemical compatibility must be guaranteed over a very long period of time, namely the entire service life of the window unit, so that a bond between the window rebate and the insulating glass module in a force-fitting manner is ensured under all weather conditions.

FIG. 2 shows a first embodiment of the window unit in accordance with the invention. Here too, only the rebate (9) of the window sash or window frame is shown. The hollow profile (3) is in this case arranged in the edge region of the panes (1) and (2) such that a U-shaped channel is left in the edge region. Disposed between the outer surfaces of the side walls (5) of the hollow profile and the inner surfaces (1.1) and (2.1.) of the pane is the first sealant (7) (primary seal), which is intended to create the gas and water vapour barrier to the interior of the panes. The second adhesive/sealant (10) performs a double function in this case: it creates a sufficiently strong connection between the hollow profile as the spacer and the two insulating glass panes, and at the same time it serves to bond the glass panes and the spacer to the window sash or window frame in a force-fitting manner.

Within the meaning of this invention, the materials used as the hollow profiles may be hollow profiles made either from purely metallic materials such as sheet steel, and even stainless steel where appropriate, or aluminium, or equally from polymeric materials, optionally in the form of coextrudates with metal films.

Formulations based on polyisobutylene and/or butyl rubber are preferably used for the sealant (7) with the high gas and water vapour barrier effect.

In order to bond the spacer on the outer surface of the rear wall of the hollow profile (6) to the edge regions of the inner surfaces (1.1) and (2.1) of the glass panes (1) and (2) the inner surface (9.1) of the rebate base, a wide range of one-component or two-component adhesives based on polyurethanes, polysulphides, silicones, acrylates or silane-modified polymers (such as MS polymers) can be used. In addition, rubber-based melt adhesives or one-component “warm-melt adhesives” based on MS polymers, polyurethanes, polysulphides, silicones or acrylates can be used. Depending on the material of the window frame or window sash, it may be necessary to provide a primer as a pre-coat on the inner surface (9.1) of the rebate. In the multi-pane window unit of the invention, the secondary edge joint of the adhesive/sealant of the insulating glass module and the adhesive for bonding the insulating glass module to the window sash or window frame in a force-fitting and sealing manner are one and the same adhesive, so that any incompatibility between different adhesives can be excluded in this case. A further advantage of the multi-pane window unit of the invention consists in the possibility of efficiently producing a complete window sash or window from the insulating glass unit and window sash frame or window frame. The production in this respect can be carried out in a plant in successive manufacturing steps by means of partially or fully automatic bonding processes. In addition, with this production process, it is possible to place the insulating glass edge unit deeper in the base of the rebate. In this way, better insulation and superior heat transmission values for the window and thus energy savings can be achieved.

FIG. 3 shows an alternative embodiment of the invention: instead of the hollow profile, the spacer used here is an elastomeric profile (8), which has a gas and water vapour barrier layer preferably on the side facing away from the interior of the panes, i.e. on the side facing the base of the rebate. Here too, the spacer is again arranged in such a way that a U-shaped channel is formed along the outer periphery between the panes and the spacer (8), which serves to accommodate the second adhesive/sealant. The above-mentioned “Super Spacers” may preferably be used here as elastomeric spacer profiles. The gaps (4) between the outer surfaces (1.2) and (2.2) of the panes and the parallel inner surfaces (9.1) of the rebate can optionally likewise be filled with the adhesive/sealant (10), but they may also be sealed in the region of the upper junction edge with a conventional elastomeric sealant. (Neither of the two embodiments is shown in FIG. 3).

FIG. 4 shows a further embodiment of a multi-pane window unit in accordance with the invention. In this embodiment, the hollow profile (3) is arranged in the edge region of the panes (1) and (2) in such a way that the outer surface of the rear wall (6) of the hollow profile forms a line with the outer edges (1.3) and (2.3) of the panes (1) and (2). In this case, the entire lower region, which is formed by the outer edges (1.3) and (2.3) and the outer surface of the rear wall (6) and also the inside (9.1) of the base of the rebate, is filled with the adhesive/sealant (10). In this case, it can be advantageous also to fill the gap (4) between the parallel inner sides (9.1) of the rebate (9) and the edge regions of the outer surfaces (1.1) and (2.1) of the panes with the adhesive/sealant (10), as is shown in FIG. 4. Optionally, however, the gap (4) may also be only partially filled with the adhesive/sealant (10), and the upper rims may be sealed with a conventional elastomeric sealant.

FIG. 5 shows a further variant of the multi-pane window unit according to FIG. 4. As in the variant according to FIG. 4, the outer surface of the rear wall (6) of the hollow profile (3) is arranged in a line with the outer edges (1.3) and (2.3) of the glass panes (1) and (2). In addition, on the rear wall in the edge region, the hollow profile has a web (6.5) projecting beyond the rear wall, which ensures that the arrangement of glass panes and spacer is kept a predetermined distance away from the inner surface (9.1) of the rebate base of the window rebate (9). Typically, this distance predetermined by the web is to 2 to 5 mm. In addition to determining the distance between the rear wall (6) of the hollow profile and the base of the rebate, this web (6.5) can also facilitate filling the gap with the adhesive/sealant (10) in a targeted manner and without air, since it determines the direction of flow of the adhesive. FIG. 5 also shows the variant that the gap (4) between the parallel inner surfaces of the rebate (9) and the outer surfaces (1.2) and (2.2) of the glass panes is only partially filled with the adhesive/sealant (10). In addition, it is shown here that the upper edge of the rebate is provided with an external seal (S1) and an internal seal (S2) of an elastomeric sealant.

FIG. 6 shows a further design of the window unit of the invention with a hollow profile (3), at the rear wall (6) of which a web (6.6) is provided in each of two edge regions. This arrangement makes it possible that only the space defined by the rear wall (6) and the webs (6.6) and the inner surface (9.1) of the base of the rebate is filled with the adhesive/sealant (10). Optionally, it is also possible for the gap (4) between the parallel surfaces of the rebate (9) and the outer surfaces (1.2) and (2.2) of the panes to be completely or partially filled with the adhesive/sealant (10). This variant is not shown in FIG. 6.

FIG. 7 shows a section of the insulating glass module with a flexible spacer profile made from a polymeric foam without the module being fitted into the window frame. The foamed basic structure of the profile (70) can consist, for example, of a flexible silicone foam or other thermoplastic elastomers already mentioned above. In a groove-shaped recess (75) is the primary sealant material of the first sealant, which serves as a water vapour and gas barrier to the gap between the panes, which will preferably be a polyisobutylene material. The secondary adhesive/sealant (72) can be based on a silicone polymer, a polyurethane polymer, a polysulphide polymer or a melt adhesive. In the embodiments in accordance with the invention, this adhesive/sealant is simultaneously the adhesive/sealant (10) for bonding the insulating glass module to the window frame or window sash in a force-fitting manner. Optionally, the flexible elastomeric foam may also have a pressure sensitive adhesive based on acrylate polymers on the side surfaces (73) in order to facilitate temporary fixing of the two panes to the spacers during assembly. On the side (74) facing away from the space between the panes, the elastomeric profile has a multi-layer vapour diffusion barrier applied to it, which can be built up from the above-mentioned polyvinylidene chloride coatings or films or from metallised polyethylene terephthalate, optionally as a combination of the two with further polymeric layers. Spacer profiles of this kind made from foamed thermoplastic elastomers are commercially available from Edgetech, as already mentioned above, under the trade name “Super Spacer”.

FIG. 8 shows a spacer in the form of a hollow profile made from a polymeric material (81), which supports a metal film (82) on the side facing away from the space between the panes. The polymeric material (81) may be a conventional PVC profile or a profile made of polypropylene, and the external metal layer (82) may be a layer of stainless steel or a layer of aluminium. Spacers of this kind are preferably manufactured by coextrusion of metal film and polymeric material. The metal film can in this case also be embedded in the matrix of the polymer material.

The production of the multi-pane window unit in accordance with the invention can be performed in different ways:

In one embodiment, the panes (1) and (2) are pre-fixed with the aid of the hollow profile (3), which is already pre-coated with the primary sealant (7), and this prefixed pane unit is then placed in the window frame or window sash, which is in a horizontal position, and the adhesive/sealant (10) is injected, optionally at high pressure, into the predefined gap between the inner surface of the base of the rebate (9.1) and the gap (4) through appropriate holes in the rebate (9). The holes in the rebate needed for this purpose are not shown in the Figures.

It goes without saying that the window unit can also be assembled vertically in appropriate mounts, in a manner similar to the one described above.

Instead of the hollow profile (3), the elastomeric foamed spacer profile (8) can be inserted in an analogous manner both for horizontal and for vertical assembly.

As a matter of principle, it is also possible to proceed in such a way that, first of all, the first pane (1) is positioned in the horizontal window frame or window sash, maintaining the gap (4). In order to maintain the gap, a washer (not shown in the Figures) can be placed between the pane and inner surface (9.1) of the rebate, but it is also possible to apply an appropriate pre-coat of the adhesive/sealant (10) to the outer surface of the pane (1.2) or the inner surface (9.1) of the rebate. In a subsequent step, the hollow profile (3) or the foamed elastomeric spacer (8), which is already pre-coated with the primary sealant (7), is fixed in the edge region of the inner surface (1.1) of the pane. After that, the pane (2) is positioned with its inner surface (2.1) on the second side of the hollow profile (3) or spacer (8) and optionally pressed gently. Then the adhesive/sealant (10), is injected, preferably under pressure, through a corresponding hole in the rebate (9)—the holes are not shown in the Figures. After the final strength has been reached, the layer formed by the adhesive/sealant (10) ensures a bond in a force-fitting and sealing manner between the insulating glass pane module and the window frame or window sash. It is optionally possible to seal the edge regions of the rebate above the gaps (4) with an elastomeric sealant (S1) or (S2) directly at the place of manufacture of the multi-pane window unit. It is, however, also possible to wait and only to create this edge seal at the place of use of the window.

### LIST OF REFERENCE NUMERALS

1 First glass pane
1.1 Inner surface of the first glass pane
1.2 Outer surface of the first glass pane
1.3 Outer edges of the first glass pane
2 Second glass pane
2.1 Inner surface of the second glass pane
2.2 Outer surface of the second glass pane
2.3 Outer edges of the second glass pane
3 Hollow profile made of metallic or polymeric material
4 Gap between the outer surfaces of the panes and the parallel inner surfaces of the rebate
5 Lateral delimiting walls of the hollow profile
6 Rear wall of the hollow profile
6.5 Web on the rear wall of the hollow profile
6.6 Webs on the rear wall of the hollow profile
7 First sealant (gas and water vapour barrier)
8 Spacer made of non-flowing polymeric material
8.3 Gas and water vapour barrier layer
9 Rebate of the window sash or window frame
9.1 Inner surfaces of the rebate
10 Second adhesive/sealant
70 Foamed thermoplastic elastomer
71 Primary sealant (gas and water vapour barrier)
72 Secondary adhesive/sealant
73 Optional pressure sensitive adhesive (assembly aid)
74 Diffusion barrier layer (optionally multi-layer)
75 Groove-shaped recess
81 Hollow profile body made from polymeric material
82 Metal film
A Spacer (hollow profile made of metal or elastomeric profile)
K1, K2 Lateral glazing blocks as aids to fixing the pane module in the rebate
K3 Lower glazing block for positioning the pane module in the rebate
S1 External seal
S2 Internal seal

1. A multi-pane window unit comprising
a. a first glass pane (1) having an inner surface (11.1) with an edge portion and an outer surface (1.2) with an edge portion,
b. a second glass pane (2) having an inner surface (2.1) with an edge portion and an outer surface (2.2) with an edge portion,
c. a spacer composed of
(c a) a hollow profile (3) which can be filled with moisture-absorbing material, and the interior for the moisture-absorbing material being delimited at least by two side walls (5) and a rear wall (6), the interior possessing a connection to the gap between the panes, a first sealant (7) being disposed between the side walls (5) of the hollow profile and the inner surfaces of the first and second glass panes, or
(c b) a spacer (S) made of a non-flowing polymeric material
d. a window sash or window frame with a rebate (9) which accommodates the glass panes, and
e. a second adhesive/sealant layer (10) for bonding the glass panes and the spacer to the window sash in a force-fitting and sealing manner,
characterised in that the hollow profile (3) is disposed in the edge portion of the inner surface of the first and second glass panes in such a way that the outer surface of the rear wall (6) forms a line with the outer edges (1.3) and (2.3) of the panes (1) and (2) and the gap between the rear wall (6) and the outer edges (1.3 and 2.3) and the inside (9.1) of the rebate (9) is filled with the adhesive/sealant (10) in order to bond multi-pane unit to the window sash or window frame in a force-fitting manner and that a projecting web (6.5) is provided at the rear wall (6) of the hollow profile.

2-5. (canceled)

6. The window unit as claimed in claim 1, characterised in that the gap (4) between the outer surfaces (1.2 and 2.2) of the panes (1 and 2) and the inside (9.1) of the rebate (9) is also filled with the adhesive/sealant (10) in order to bond the multi-pane unit to the window sash or window frame in a force-fitting manner.

7-8. (canceled)

9. The window unit as claimed in claim 10, characterised in that the gap (4) between the outer surfaces (1.2 and 2.2) of the panes (1 and 2) and the inside (9.1) of the rebate (9) is also filled with the adhesive/sealant (10) in order to bond the multi-pane unit to the window sash or window frame in a force-fitting manner.

10. A multi-pane window unit comprising
a. a first glass pane (1) having an inner surface (1.1) with an edge portion and an outer surface (1.2) with an edge portion,
b. a second glass pane (2) having an inner surface (2.1) with an edge portion and an outer surface (2.2) with an edge portion,
c. a spacer composed of
(c a) a hollow profile (3) which can be filled with moisture-absorbing material, the interior for the moisture-absorbing material being delimited at least by two side walls (5) and a rear wall (6), the interior possessing a connection to the gap between the panes, a first sealant (7) being disposed between the side walls (5) of the hollow profile and the inner surfaces of the first and second glass panes, or
(c b) a spacer (8) made of a non-flowing polymeric material,
d. a window sash or window frame with a rebate (9) which accommodates the glass panes, and
e. a second adhesive/sealant layer (10) for bonding the glass panes and the spacer to the window sash in a force-fitting and sealing manner,
characterised in that the hollow profile (3) is disposed in the edge portion of the inner surface of the first and second glass panes in such a way that the outside of the rear wall (6) forms a line with the outer edges (1.3) and (2.3) of the panes (1) and (2) and that two projecting webs (6.5) are provided at the rear wall (6) of the hollow profile, wherein only the space formed by the rear wall (6) of the hollow profile, the two projecting webs (6.5) and the inside (9.1) of the rebate (9) is filled with the adhesive/sealant (10) in order to bond the multi-pane unit to the window sash or window frame in a force-fitting manner.
